(19) United States
(12) Patent Application Publication
(10) Pub. No.: US 2011/0069317 A1
(43) Pub. Date: Mar. 24, 2011

(54) RETROVIEWERS

(75) Inventor: Paul J. Northey, Somerset, WI (US)

(73) Assignee: 3M Innovative Properties Company

(21) Appl. No.: 12/829,576

(22) Filed: Jul. 2, 2010

Related U.S. Application Data
(60) Provisional application No. 61/243,871, filed on Sep. 18, 2009.

(51) Int. Cl. G01N 21/55

(52) U.S. Cl. 356/445

(57) ABSTRACT

The present application generally relates to retroviewers for use in viewing one or more retroreflective articles. One exemplary retroviewer for use in viewing a retroreflective article at a distance of between about 5 feet and about 30 feet includes a housing portion including a tubular body that forms a handle, the housing portion capable of holding at least one light source; and a viewing portion adjacent to the housing portion and including a viewing passageway having a longitudinal axis that perpendicularly intersects a longitudinal axis of the tubular body.

### RELATED APPLICATION

This application claims the benefit under 35 U.S.C. §119(e) of U.S. Provisional Application No. 61/243, 871 filed Sep. 18, 2009.

### TECHNICAL FIELD

The present application generally relates to retroviewers for use in viewing one or more retroreflective articles.

### BACKGROUND

Retroreflective materials are characterized by the ability to redirect light incident on the material back toward the originating light source. This property has led to the widespread use of retroreflective sheeting for a variety of traffic and personal safety uses. Retroreflective sheeting is commonly employed in a variety of articles, for example, road signs, barricades, license plates, pavement markers and marking tape, as well as retroreflective tapes for vehicles and clothing.

It is often desirable to assess the retroreflectivity of articles including retroreflective sheeting in order to ensure their compliance with safety guidelines. Because retroreflective sheeting made by differing sheeting manufacturers or distributors often exhibits differing retroreflectivity at given angles, it is also desirable to compare the retroreflectivity of samples of retroreflective sheeting and/or articles including retroreflective sheeting. Existing retroviewers capable of visually assessing retroreflectivity are described in U.S. Pat. No. 3,767,291 (issued Oct. 23, 1973) and U.S. Pat. No. 3,832,038 (issued Aug. 27, 1974), both of which were assigned to the assignee of the present application. These patents describe, respectively, a table-top and handheld retroviewer capable of verifying a document having a retroreflective image bearing layer which is substantially transparent under diffuse light viewing conditions to provide viewing of images on an underlying surface.

### SUMMARY

The inventor of the present application recognized that the existing retroviewers had certain drawbacks. One such drawback is their production of a virtual image having an area of less than 0.5 square inch. In some instances, different sized, and often larger, virtual images may be desired. Another drawback is that existing retroviewers have an angle of divergence from the illumination axis of from 0.2° to about 2°. In some instances, different angles of divergence may be desired. Further, existing retroviewers are largely used to detect retroreflectivity at a distance of between about 0.5 foot to about 2 feet. This distance range is at least partially dependent on the construction of the existing retroviewers and their inclusion of beam splitters and small, low-intensity lights.

In some instances, detection of retroreflectivity at different distances may be desired. For example, when viewing retroreflective sheeting for use in or when viewing a license plate, detection of retroreflectivity at a distance of between about 5 feet and about 100 feet, for example, may be desired. Existing retroviewers are inadequate for visual detection of retroreflectivity at this distance.

Consequently, the inventor of the present application designed various retroviewers capable of detecting retroreflectivity at multiple observation angles and greater viewing distances. Retroviewers of the present application facilitate a comparison of retroreflective materials under multiple scenarios simulating real world viewing conditions that are critical in the use of vehicle license plates, traffic signs, and the like. For example, both small observation angles (0.1 degrees to about 1.0 degrees, more preferably between about 0.2 degrees and about 0.4 degrees) for long-distance safety scenarios and larger observation angles (between about 1.1 degrees and greater than 2 degrees) for license plate reading scenarios can be created using the retroviewers of the present application. The user can choose retroviewer dimensions and angles suitable for the desired applications (e.g., demonstration of retroreflectivity in an office environment).

In one embodiment of the present application, a retroviewer for use in viewing a retroreflective article at a distance of between about 5 feet and about 100 feet includes (1) a housing portion including a body that forms a handle, the housing portion capable of holding at least one light source; and (2) a viewing portion adjacent to the housing portion and including a viewing passageway having a longitudinal axis that perpendicularly intersects a longitudinal axis of the body.

In another embodiment of the present application, a retroviewer for use in viewing a retroreflective article includes (1) a housing portion including a tubular body that (a) forms a handle and (b) that is capable of holding a first light source capable of emitting light along a first illumination axis and (c) that is capable of holding a second light source capable of emitting light along a second illumination axis, wherein the first and second light sources positioned perpendicular to a longitudinal axis of the tubular body and separated by a distance d; and (2) a viewing portion adjacent to the housing portion and including a viewing passageway having a longitudinal axis that perpendicularly intersects the longitudinal axis of the tubular body, wherein the viewing portion further includes an eyepiece.

In another embodiment of the present application, an adjustable retroviewer for use in viewing a retroreflective article includes: (1) a housing portion including a body that forms a handle and that is capable of holding a light source capable of emitting light along a first illumination axis; and (2) a viewing portion adjacent to the housing portion and including a viewing passageway having a longitudinal axis that perpendicularly intersects the longitudinal axis of the body, the viewing portion further including an eyepiece and a flange into which body may be fitted. In this embodiment, the distance between the viewing portion and the light source can be altered by movement of the body along its longitudinal axis into the flange.

### BRIEF DESCRIPTION OF DRAWINGS

FIG. 1 is a front view of a retroviewer of the type described herein.

FIG. 2 is a side view of the retroviewer of FIG. 1.

FIG. 3 is a cross-sectional view of the retroviewer of FIGS. 1 and 2.

FIG. 4 is a cross-sectional view of an alternative, adjustable retroviewer.

FIG. 5 is a schematic view of retroviewers of the present application in operation.

### DETAILED DESCRIPTION

Retroviewers of the present application are capable of assessing retroreflectivity of retroreflective articles, including, but not limited to, retroreflective sheeting, signs, license plates, documents, and the like. At least some of the retroviewers are handheld in that they can be held up to the user's eye by the user's hand.

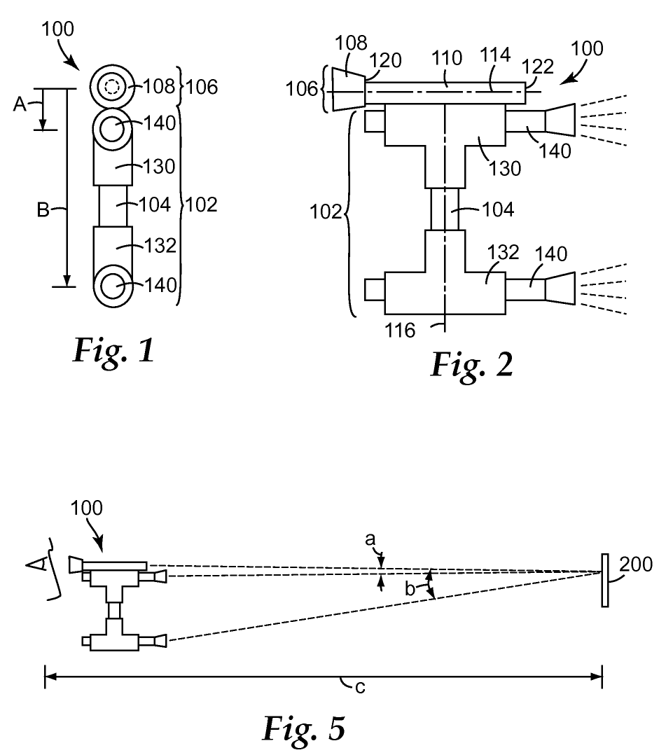

One exemplary embodiment of a retroviewer of the present application is shown in FIGS. 1-3. Retroviewer 100 includes a housing portion 102, including a body 104 (e.g., tubular or flat) defining a handle, and a viewing portion 106 adjacent to housing portion 102. Viewing portion 106 includes an eyepiece 108 connected to a viewing passageway 110 having a longitudinal axis 114 that perpendicularly intersects a longitudinal axis 116 of body 104. The ends of viewing passageway 110 are designated 120 and 122. The location of eyepiece 108 facilitates positioning of the eye of the user at a predetermined viewing position and distance from the retroreflective article.

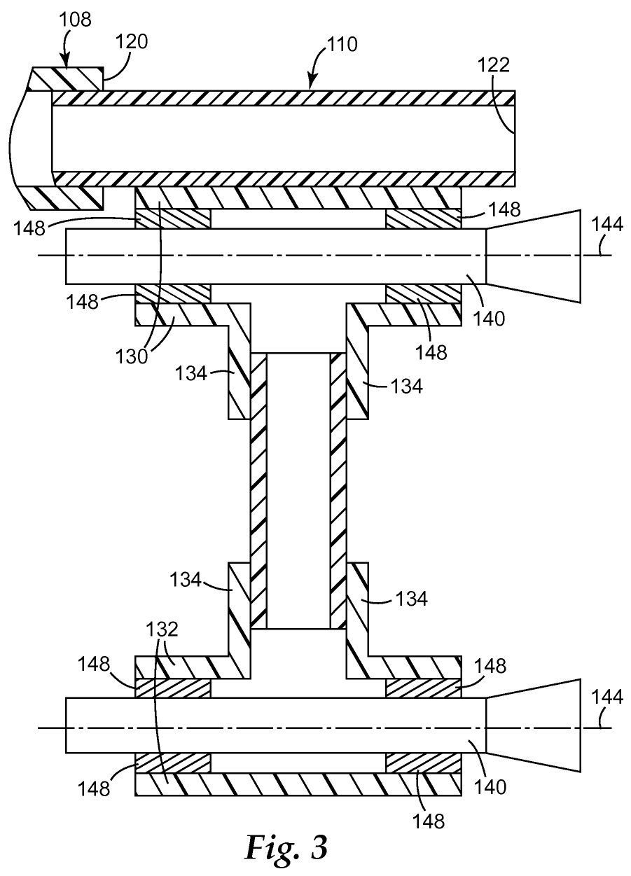

Housing portion 102 includes an upper housing portion 130 and a lower housing portion 132, each of which are connected to body 104 by one or more connection means 134 such as, for example, the T-joints shown in FIG. 3. Upper housing portion 130 and lower housing portion 132 are each capable of receiving and/or holding a light source 140. One exemplary light source that may be used in the retroviewers of the present application is a flashlight manufactured and sold by Maglite™. One benefit of this type of light source is that the user can move the reflector and therefore change the diameter of the cone of light emitted by the light source. Light sources 140 are held within upper housing portion 130 and lower housing portion 132 by holding means 142 such as, for example, the bushings 148 shown in FIG. 3. As shown in FIGS. 2 and 3, the longitudinal axis 144 of light sources 140 is generally parallel to longitudinal axis 114 of viewing passageway 110. Light sources 140 preferably include their own power source and can preferably be removed from upper housing portion 130 and lower housing portion 132 to facilitate easy replacement of light sources 140 when their respective energy sources expire. Ease of removability of light sources 140 also provides the user with the ability to easily alter the type of light source(s) used in retroviewer 100.

Those of skill in the art will appreciate that many changes can be made to the specific embodiment shown in FIGS. 1-3 without departing from the scope of the present application. For example, alternative retroviewers of the present application are adjustable in that the distance between adjacent light sources 140 can be varied. Additionally, retroviewers of the present application can include fewer or more light sources 140. Additionally, connection means 134 and holding means 142 can be devices other than those shown in FIGS. 1-3 and described above. Additionally, the retroviewers may include their own power sources or light source(s) 140 may be fixed in the retroviewer such that they are not removable. Also, body 104 can be of any shape including, for example, tubular and flat.

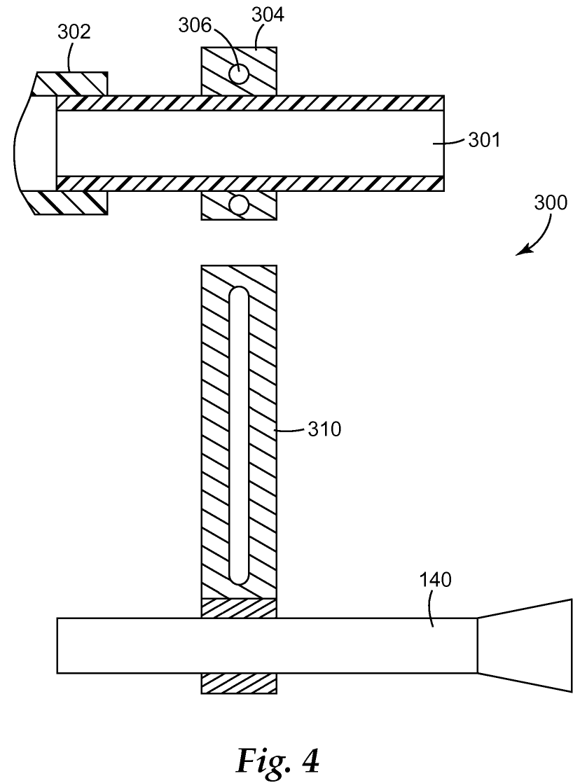

A cross-sectional view of one exemplary embodiment of an adjustable retroviewer 300 including only one light source 140 is shown in FIG. 4. Adjustable retroviewer 300 includes a viewing portion 301 including an eyepiece 302 that is similar to viewing portion 106 of FIGS. 1-3. However, viewing portion 301 includes a flange 304 having a longitudinal axis perpendicular to longitudinal axis 114 and also having threaded holes 306 capable of accepting connection mechanisms, such as, for example, screws. Adjustable retroviewer 300 also includes a single light source 140 that is attached to a slotted post 310 that fits within and is capable of connection to flange 304. The distance between light source 140 and viewing portion 301 can be adjusted by loosening the connection mechanisms (e.g., screws), sliding slotted post 310 to the desired location (scale markings printed along slotted post 310 could show observation angle at given viewing distance(s)), and tightening the connection mechanisms (e.g., screws) to lock retroviewer 300 in a desired position. Preferred implementations would permit enough play in slotted post 310 to allow slight upward tilt to light source 140 to keep the cone of light emitted from light source 140 inside the view of eyepiece 302 at larger observation angles. Slotted post 310 can be, for example, flat or tubular.

Retroviewers of the present application are particularly useful for verification of retroreflective articles that are viewed at a distance of between about 5 feet and 100 feet, more preferably between about 10 feet and about 50 feet, and most preferably between about 15 feet and about 30 feet. One such retroreflective article is a license plate or a sample of license plate sheeting. FIG. 5 schematically illustrates use of the retroviewers described above to view a retroreflective license plate under normal, indoor, diffuse lighting conditions.

The viewing position defined by eyepiece 108 is spaced approximately the same distance from the retroreflective article as the light source(s) 130 and 132. Further, in at least some preferred embodiments, eyepiece 108 is secured to housing portion 102 to position the user's eye along a viewing axis at a slight downward angle of about 0.1° to about 1.5°, more preferably between about 0.5° to 1°.

As shown in FIG. 5, at least some embodiments of the non-adjustable retroviewer provide two different observation angles: observation angle “a” is the angle between the eyepiece and the first light source and observation angle “b” is the angle between the eyepiece and the second light source. In at least some embodiments of the non-adjustable retroviewer, the user can only change the distance between the retroviewer and the retroreflective article. Changing this distance will change the observation angles (moving the retroviewer closer to the retroreflective article will create larger observation angles and moving the retroviewer farther from the retroreflective article will create smaller observation angles). The height the retroviewer is held above the retroreflective article will not substantially change the observation angles as long as the eyepiece is aimed at the retroreflective article.

In at least some embodiments of the adjustable retroviewer, the user can change (1) the distance between the retroviewer and the retroreflective article and (2) the distance between the eyepiece and the single light source to change the observation angle. As was stated above, moving the retroviewer closer to the retroreflective article will create larger observation angles and moving the retroviewer farther from the retroreflective article will create smaller observation angles. In at least some embodiments of the adjustable retroviewer, two light sources are not required because any observation angle is possible between the minimum and maximum slot positions.

The retroviewers of the present application allow the viewer to visually detect retroreflectivity and retroluminance (the product of retroillumination and retroreflectance).

### Example 1

A prototype of the retroviewer shown in FIGS. 1-3 was prepared. The upper and lower housings, viewing portion, and tubular body were made from PVC tubing having a diameter of approximately 0.75 inch. The connection means used were T-joints, and the holding means used were bushings. The light sources were Maglite™ flashlights having adjustable bulbs. The distance between the eyepiece and the upper light source (designated as “A” in FIG. 1) was approximately 1 inch. The distance between the eyepiece and the lower light source (designated as “B” in FIG. 1) was approximately 6 inches. At a viewing distance (designated as “C” in FIG. 5) of approximately 15 feet, the observation angles of the retroviewer (designated as “a” and “b” of FIG. 5) were approximately 0.3 degree and 2.0 degree, respectively.

The recitation of all numerical ranges by endpoint is meant to include all numbers subsumed within the range (i.e., the range 1 to 10 includes, for example, 1, 1.5, 3.33, and 10).

Those having skill in the art will appreciate that many changes may be made to the details of the above-described embodiments and implementations without departing from the underlying principles thereof. Further, various modifications and alterations of the embodiments and implementations described and shown in the present application will become apparent to those skilled in the art without departing from the spirit and scope of the application. The scope of the present application should, therefore, be determined only by the following claims.

What is claimed is:

1. A retroviewer for use in viewing a retroreflective article at a distance of between about 5 feet and about 100 feet, comprising:
a housing portion including a body that forms a handle, the housing portion capable of holding at least one light source; and
a viewing portion adjacent to the housing portion and including a viewing passageway having a longitudinal axis that perpendicularly intersects a longitudinal axis of the body.

2. The retroviewer of claim 1, further including an eyepiece secured to the viewing passageway for positioning the eye of a user at a predetermined viewing position.

3. The retroviewer of claim 2, wherein said eyepiece is secured to the viewing passageway to position the eye of a user along a viewing axis at an angle of divergence from the illumination axis defined by the at least one light source of from about 0.1 degree to about 4 degrees.

4. The retroviewer of claim 3, wherein said angle of divergence is between about 0.4 degree to about 0.6 degree.

5. The retroviewer of claim 1, wherein the cone of light emitted by the light source is adjustable.

6. The retroviewer of claim 1, including two light sources.

7. The retroviewer of claim 1, including a single light source whose distance from the viewing portion is adjustable.

8. The retroviewer of claim 1, wherein the retroviewer is capable of detecting retroreflectivity at a distance of between about 10 feet and about 50 feet.

9. The retroviewer of claim 1, wherein the retroviewer is a handheld retroviewer.

10. The retroviewer of claim 1, wherein the at least one light source is removable.

11. A retroviewer for use in viewing a retroreflective article, comprising:
a housing portion including:
a tubular body that forms a handle and that is capable of holding a first light source capable of emitting light along a first illumination axis and a second light source capable of emitting light along a second illumination axis, the first and second light sources positioned perpendicular to a longitudinal axis of the tubular body and separated by a distance d; and
a viewing portion adjacent to the housing portion and including a viewing passageway having a longitudinal axis that perpendicularly intersects the longitudinal axis of the tubular body, the viewing portion further including an eyepiece.

12. The retroviewer of claim 11, wherein the distance d is between about 2 inches and about 10 inches.

13. An adjustable retroviewer for use in viewing a retroreflective article, comprising:
a housing portion including a body that forms a handle and that is capable of holding a light source capable of emitting light along a first illumination axis; and
a viewing portion adjacent to the housing portion and including a viewing passageway having a longitudinal axis that perpendicularly intersects the longitudinal axis of the body, the viewing portion further including an eyepiece and a flange into which body may be fitted;
wherein the distance between the viewing portion and the light source can be altered by movement of the body along its longitudinal axis into the flange.
